(19) United States
(12) Patent Application Publication
(10) Pub. No.: US 2007/0043507 A1
(43) Pub. Date: Feb. 22, 2007

(54) VEHICLE COLLISION DETECTION DEVICE

(75) Inventor: Shigeo Tobaru, Wako-shi, Saitama (JP)

Correspondence Address: RANKIN, HILL, PORTER & CLARK LLP, 4080 ERIE STREET, WILLOUGHBY, OH, 44094-7836, US

(73) Assignee: HONDA MOTOR CO., LTD., Tokyo (JP)

(21) Appl. No.: 11/465,277

(22) Filed: Aug. 17, 2006

(30) Foreign Application Priority Data
Aug. 19, 2005 (JP) 2005-238699

(51) Int. Cl. G08G 1/16; G06F 17/10

(52) U.S. Cl. 701/301; 340/436

(57) ABSTRACT

A vehicle collision detection device includes a plurality of sensors for detecting at least one parameter selected from an acceleration that acts upon the vehicle body and a deformation induced in the vehicle body by the acceleration, and then wirelessly generating an output signal, and a controller for assessing collisions on the basis of the output signal received from the sensors. Each sensor includes a distinguished value memory part for storing a characteristic distinguished value for each of the sensors, a transmitter for transmitting the distinguished value together with the output signal to the controller, and a power generator for producing electric power by an external force and feeding the power to the transmitter.

### FIELD OF THE INVENTION

The present invention relates to a device for detecting a vehicle collision.

### BACKGROUND OF THE INVENTION

Among vehicle collision detection devices, there are devices in which the acceleration acting upon a vehicle body or the displacement of the vehicle body is detected by a sensor, and the collision is assessed by a controller on the basis of information about the detected acceleration or displacement. A technique in which a plurality of sensors is arrayed in a vehicle body and the sensors are connected to a controller by electric wires is disclosed as such a vehicle collision detection device in Japanese Laid-Open Patent Publication No. 2005-147983 (JP-A-2005-147983).

The vehicle collision detection device disclosed in JP-A-2005-147983 will be described based on FIG. 8 hereof.

The conventional vehicle collision detection device 200 comprises a piezoelectric film 202 provided to an inner surface of a front bumper face 201, electrode pairs 203 formed at a plurality of locations on the piezoelectric film 202, a signal-processing circuit 205 connected to the electrode pairs 203 by electric wires 204, and a controller 207 connected to the signal-processing circuit 205 by an electric wire 206.

However, the vehicle collision detection device 200 necessitates the use of the electric wires 204 for connecting all of the electrode pairs 203 and the signal-processing circuit 205, as well as the electric wire 206 for connecting the signal-processing circuit 205 and the controller 207. Numerous electric wires 204, 206 are thereby arrayed, the configuration of the vehicle collision detection device 200 is therefore complex, and there is less latitude in positioning the vehicle collision detection device 200.

In view of the above, there is a need for a technique in which a vehicle collision detection device can be configured in a simple manner, and the vehicle collision detection device can be positioned with a great degree of freedom.

### SUMMARY OF THE INVENTION

According to a first aspect of the present invention, there is provided a vehicle collision detection device which comprises: a plurality of sensors for detecting at least one parameter selected from an acceleration that acts upon a vehicle body from the outside and a deformation induced in the vehicle body in accordance with the acceleration, and then wirelessly generating an output signal; and a controller for assessing collisions based on the output signal received from the sensors, wherein each of the sensors has a distinguished value memory part for storing a characteristic distinguished value for each of the sensors, a transmitter for transmitting the distinguished value together with the output signal to the controller, a power generator for producing electric power by an external force, and a power storage part for storing the electric power produced by the power generator and for supplying the electric power to the transmitter.

The output signals (acceleration, deformation) that are detected by the sensors can therefore be wirelessly transmitted from the transmitter of the sensors to the controller. Wiring for connecting the sensors and the controller is not necessary. Furthermore, the sensors comprise a power generator for producing electric power corresponding to an external force, and for providing the electric power to the transmitter.

In this way, wiring is not necessary. The structure of the vehicle collision detection device can therefore be simplified and the cost of the device can be reduced. Additionally, the controller is separated from the sensors. Therefore, the collision detection device can be positioned in the vehicle with a great degree of freedom.

The sensors also comprise a distinguished value memory part for storing a characteristic distinguished value for each of the sensors and a transmitter for transmitting the distinguished value together with the output signal to the controller. For this reason, the controller can accurately determine from which of the sensors the output signal was received. Therefore, the controller can accurately assess collisions based on the output signal received from the sensors.

According to a second aspect of the present invention, a vehicle collision detection device comprising a plurality of sensors for detecting at least one parameter selected from an acceleration that acts upon a vehicle body from the outside, and a deformation induced in the vehicle body in accordance with the acceleration, and then wirelessly generating an output signal; and a controller for assessing collisions based on the output signal received from the sensors is provided, wherein each of the sensors has a distinguished value memory part for storing a characteristic distinguished value for each of the sensors; a transmitter for transmitting the distinguished value together with the output signal to the controller; a power generator for producing electric power by an external force; and a power storage part for storing the electric power produced by the power generator and for feeding the power to the transmitter.

The output signals that are detected by the sensors can therefore be wirelessly transmitted from the transmitter of the sensors to the controller. Wiring for connecting the sensors and the controller is not necessary. Furthermore, the sensors comprise a power generator for producing electric power corresponding to an external force and for providing the electric power to the transmitter.

In this way, wiring is not necessary. The structure of the vehicle collision detection device can therefore be simplified and the cost of the vehicle collision detection device can be reduced. Additionally, the controller is separated from the sensors. Therefore, the vehicle collision detection device can be positioned in the vehicle with a great degree of freedom.

The sensors also comprise a distinguished value memory part for storing a characteristic distinguished value for each of the sensors and a transmitter for transmitting the distinguished value together with the output signal to the controller. For this reason, the controller can accurately determine from which of the sensors the output signal was received. Therefore, the controller can accurately assess collisions based on the output signal received from the sensors.

A power storage part for storing the electric power produced by the power generator is additionally provided to the sensors. The electric power stored in the power storage part can therefore be fed to the transmitter. For this reason, the power provided to the transmitter from the power storage part can be kept stable even when there are fluctuations in the electric power produced by the power generator. Therefore, the transmitter can transmit a more steady output signal.

According to a third aspect of the present invention, there is provided a vehicle collision detection device comprising a plurality of sensors for detecting at least one parameter selected from an acceleration that acts upon a vehicle body from the outside, and a deformation induced in the vehicle body in accordance with the acceleration, and then wirelessly generating an output signal; a controller for assessing collisions based on the output signal received from the sensors and wirelessly transmitting a diagnosis instruction to the sensors and performing a failure diagnosis on the sensors; and an electromagnetic wave generator for wirelessly generating electromagnetic waves to the sensors, wherein each of the sensors has a distinguished value memory part for storing a characteristic distinguished value for each of the sensors; a transmitter-receiver for transmitting the distinguished value together with the output signal to the controller and for receiving the diagnosis instruction; a first power generator for producing electric power by an external force, and feeding the power to the transmitter-receiver; and a second power generator for receiving the electromagnetic waves from the electromagnetic wave generator, producing electric power by converting the electromagnetic waves to electric power, and feeding the power to the transmitter-receiver.

The output signals that are detected by the sensors can therefore be wirelessly transmitted from the transmitter of the sensors to the controller. Wiring for connecting the sensors and the controller is not necessary. Furthermore, the sensors comprise a first power generator for producing electric power corresponding to an external force and a second power generator for producing electric power using the electromagnetic waves received from the electromagnetic wave generator.

In this way, wiring is not necessary. The structure of the vehicle collision detection device can therefore be simplified and the cost of the vehicle collision detection device can be reduced. Additionally, the controller is separated from the sensors. Therefore, the vehicle collision detection device can be positioned in the vehicle with a great degree of freedom.

The sensors also comprise a distinguished value memory part for storing a characteristic distinguished value for each of the sensors and a transmitter for transmitting the distinguished value together with the output signal to the controller. For this reason, the controller can accurately determine from which of the sensors the output signal was received. Therefore, the controller can accurately assess collisions based on the output signal received from the sensors.

Electric power can also be fed from both the first power generator and the second power generator to the transmitter-receiver. For example when the vehicle is in a stopped state and an impact force is not acting on the vehicle body from the outside, the first power generator does not generate electric power corresponding to an external force. However, the transmitter-receiver is capable of operating on only the electric power supplied from the second power generator. When a diagnostic instruction is sent wirelessly from the controller to the sensors, the transmitter-receivers in the sensors adequately receive the diagnostic instruction, and signal processing can be performed. Therefore, failure diagnosis can adequately be performed on the sensors at any time without experiencing temporal constraints. As a result, the dependability of the vehicle collision detection device can be further increased.

### BRIEF DESCRIPTION OF THE DRAWINGS

Certain preferred embodiments of the present invention will be described in detail below, by way of example only, with reference to the accompanying drawings, in which:

FIG. 1 is a perspective view of a vehicle comprising a vehicle collision detection device according to a first embodiment of the present invention;

FIG. 2 is a block diagram of the vehicle collision detection device shown in FIG. 1;

FIGS. 3A and 3B are views for describing the operation of the vehicle collision detection device shown in FIG. 1;

FIG. 4 is a block diagram of a modification of the vehicle collision detection device shown in FIG. 1;

FIG. 5 is a perspective view of a vehicle comprising a vehicle collision detection device according to a second embodiment of the present invention;

FIG. 6 is a block diagram of the vehicle collision detection device shown in FIG. 5;

FIG. 7 is a view for describing the operation of the vehicle collision detection device shown in FIG. 5; and

FIG. 8 is a view for describing a conventional vehicle collision detection device.

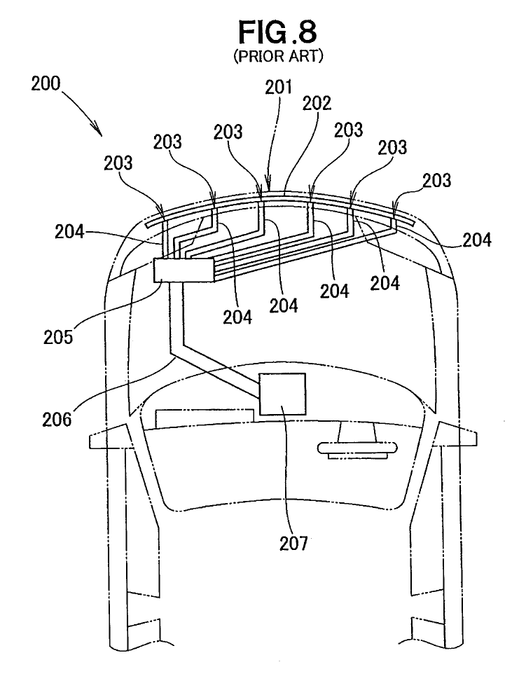

### DETAILED DESCRIPTION OF THE PREFERRED EMBODIMENTS

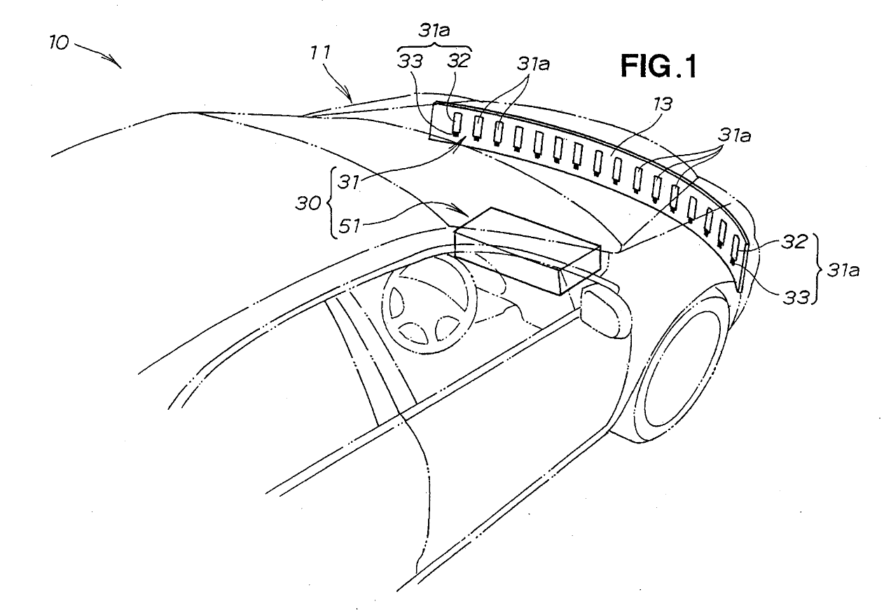

First, a vehicle collision detection device according to a first embodiment shall be described based on FIGS. 1, 2, 3A, and 3B.

As shown in FIG. 1, the vehicle 10 comprises the vehicle collision detection device 30 of the first embodiment. The vehicle collision detection device 30 has a collision detection unit 31 and a controller 51. The collision detection unit 31 has a plurality of sensors 31a.

The sensors 31a detect at least one parameter selected from an acceleration that acts upon the vehicle body 11 from the outside, and a deformation induced in the vehicle body 11 in accordance with the acceleration. The sensors then wirelessly generate an output signal.

The sensors 31a are disposed in proximity to an outer surface (the panel covering the vehicle body 11) of the vehicle 10, and are attached to a portion that deforms in accordance with the force of impact from the vehicle 10 coming into contact with an external obstacle. For example, a front bumper face 13 that covers a front bumper may be disposed on a portion that can be deformed in such a way. The front bumper face 13 shall hereafter be referred to as “the bumper face 13.” The bumper face 13 may, for example, be a deformable member composed of a resin product. More specifically, the sensors 31a are arrayed at regular intervals in a single row in the width direction of the vehicle, and are mounted inside the bumper face 13 in a direct or indirect fashion. On the other hand, the controller 51 is attached to the inside of the vehicle 10.

One sensor from among the sensors 31a shall now be described in detail. The other sensors 31a have the same configuration.

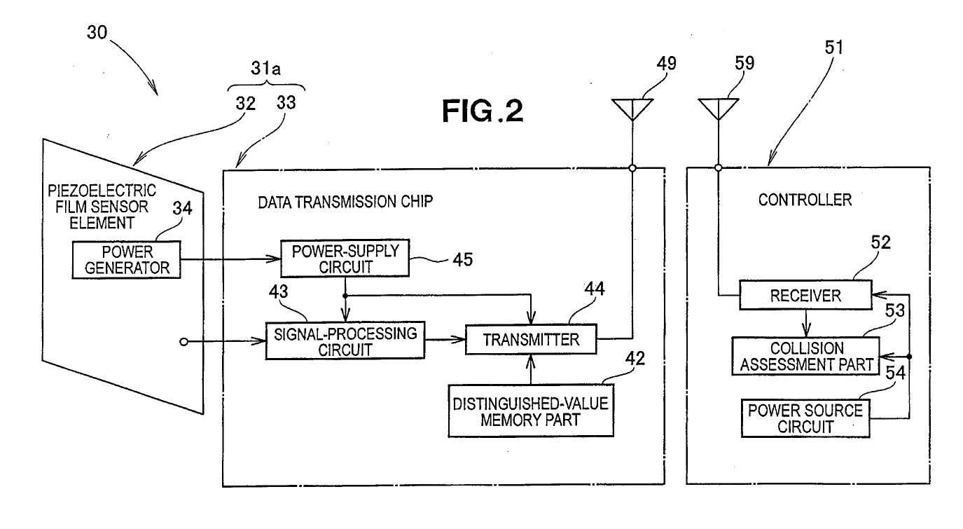

As shown in FIGS. 1 and 2, the sensor 31a has a piezoelectric film sensor element 32 and a data transmission chip 33 that is integrally mounted to the piezoelectric film sensor element 32.

The piezoelectric film sensor element 32 has a piezoelectric film and electrodes mounted to both surfaces of the piezoelectric film. The piezoelectric film is a flexible film composed of a polymer substance and has a piezoelectric effect. Therefore, the piezoelectric film generates an electric charge when strained by an external force and, conversely, generates strain when an electric charge is applied. A voltage signal that corresponds to the strain in the piezoelectric film can be drawn from the electrodes. This voltage signal is the detection signal of the piezoelectric film sensor element 32. The piezoelectric film sensor element 32 shall hereafter be referred to as “the sensor element 32.” The film surface of the piezoelectric film faces the front surface of the vehicle 10.

As described above, the bumper face 13 deforms in accordance with an acceleration that acts from the outside, i.e., in accordance with the impact force created by contact with an obstacle. The piezoelectric film of the sensor element 32 is strained in accordance with the deformation of the bumper face 13. The sensor element 32 generates a detection signal that corresponds to the strain in the piezoelectric film.

In summary, the following description can be given. The sensor element 32 detects the acceleration that acts upon the bumper face 13 from the outside, and generates a detection signal. This detection signal is also a signal corresponding to the deformation of the bumper face 13. Therefore, it can be said that the sensor element 32 detects at least one parameter selected from the acceleration that acts upon the vehicle body 10 and the deformation induced in the vehicle body 10 in accordance with the acceleration, and generates a detection signal.

As shown in FIG. 2, the sensor element 32 comprises a power generator 34. The power generator 34 produces electric power corresponding to an external force. As described above, the piezoelectric film of the sensor element 32 has a piezoelectric effect. Power can be produced using this piezoelectric effect. The part having the power generation function is the power generator 34. In other words, the piezoelectric film doubles as the power generator 34.

As used herein, the term “external force” refers to a force that creates strain in the piezoelectric film, and includes, for example, vibrations of the vehicle 10 as such in addition to the impact force of an obstacle that comes into contact with the bumper face 13 shown in FIG. 1. These vibrations include those produced by an engine and those occurring during travel.

The impact force that acts on the bumper face 13 is extremely large in comparison with other external forces. For this reason, when the sensor element 32 is subjected to an impact force, a detection signal is generated and a comparatively large electric power is produced. Because other external forces are extremely small in comparison with impact force, there is no effect on the detection accuracy of the sensor element 32.

As shown in FIG. 2, the data transmission chip 33 has a distinguished-value memory part 42, a signal-processing circuit 43, a transmitter 44, a chip-side power-supply circuit 45, and a chip-side antenna 49. The data transmission chip 33 is formed by, for example, being printed on a film-type substrate.

The distinguished-value memory part 42 stores in advance the characteristic distinguished value for each of the sensors 31a, and is also referred to as an ID data memory part. The term “distinguished value” refers to a characteristic value (address) for distinguishing the location of each sensor 31a among the plurality of sensors 31a arrayed in a single row, and is also referred to as a distinguished-value signal. Each distinguished value is composed, for example, of an ID code (also referred to as ID data). In this way, a characteristic distinguished value is assigned to each of the sensors 31a.

The signal-processing circuit 43 converts the detection signal (voltage signal) received from the sensor element 32 to an output signal that corresponds to the acceleration or displacement. The detection signal can be converted to a variety of types of output signals, and is not limited to a voltage signal.

The transmitter 44 combines and simultaneously transmits the output signal received from the signal-processing circuit 43 and the self-distinguished value received from the distinguished value memory part 42. The compound signal of the distinguished value combined with the output signal shall hereafter be referred to as “an output signal having a distinguished value.”

The chip-side power-supply circuit 45 rectifies the voltage and keeps the voltage at a constant level in the power fed from the power generator 34. The power generator 34 feeds the power to the signal-processing part 43 and the transmitter 44 via the chip-side power generation circuit 45.

The chip-side antenna 49 is a transmission antenna for wirelessly transmitting the output signal having a distinguished value that is transmitted from the transmitter 44.

The controller 51 shall next be described. As shown in FIGS. 1 and 2, the controller 51 assesses collisions on the basis of the output signal having a distinguished value that is transmitted from each of the sensors 31a, and controls an airbag, seat belt, and other passenger protection devices (not shown) on the basis of assessment results. The controller 51 controls the passenger protection devices, and is therefore also referred to as an SRS control unit SRS is an abbreviation of “Supplementary Restraint System.” As shown in FIG. 2, the controller 51 has a receiver 52, a collision assessment part 53, a unit-side power supply circuit 54, and a unit-side antenna 59.

The unit-side antenna 59 is a reception antenna for wirelessly receiving the output signal having a distinguished value that is transmitted from the transmitter 44 via the chip-side antenna 49.

The receiver 52 receives the output signal having a distinguished value via the unit-side antenna 59, decrypts the output signal having a distinguished value, and determines the output signal and the distinguished value.

The collision assessment part 53 evaluates the presence or absence of a collision involving the vehicle 10 (see FIG. 1), the mode of the collision, and the magnitude of the impact force on the basis of the output signal and distinguished value received from the receiver 52; and controls the passenger protection devices on the basis of the results of this evaluation.

The unit-side power-supply circuit 54 contains a power supply, rectifies and keeps constant the voltage in the power fed from this power supply, and feeds power to the receiver 52 and collision assessment part 53.

An operation of the vehicle collision detection device 30 of the first embodiment shall next be described.

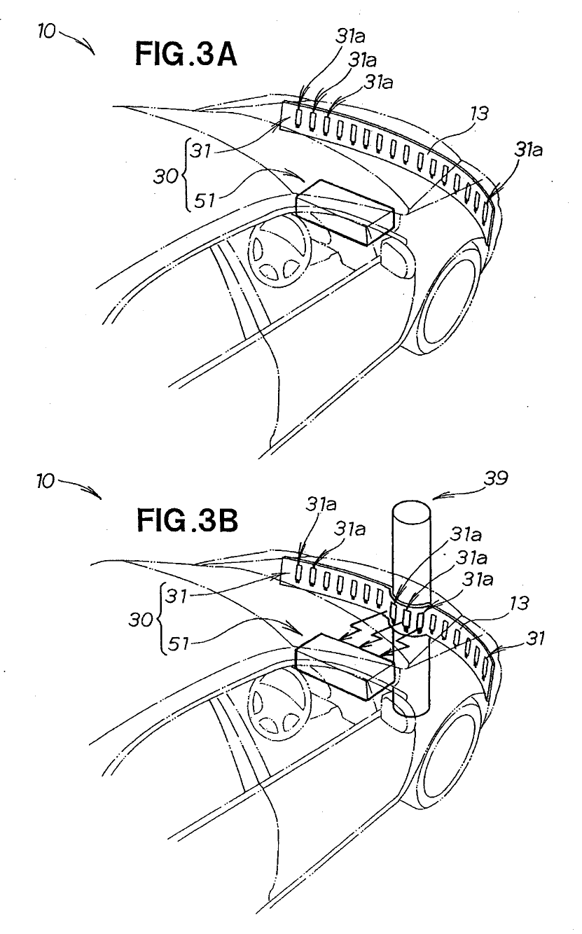

As shown in FIG. 3A, none of the sensors 31a transmits an output signal in a normal state in which the vehicle 10 has not sustained a collision. The controller 51 is therefore in a standby state.

As shown in FIG. 3B, when the vehicle 10 comes into contact with an obstacle 39, the bumper face 13 deforms according to the impact force, i.e., according to the acceleration. For example, when the central portion of the width of the vehicle 10 comes into contact with the obstacle 39, the central portion of the width of the bumper face 13 deforms. The sensors 31a transmit an output signal in response to the deformation of the bumper face 13. Among the sensors 31a, the output signal of the sensor 31a corresponding to a portion where the deformation of the bumper face 13 is significant has a high value.

The controller 51 wirelessly receives the output signal of the sensors 31a; evaluates the mode of the collision involving the vehicle 10 and the magnitude of the impact force; and controls the passenger protection devices on the basis of the results of this evaluation.

According to the vehicle collision detection device 30 of the first embodiment, as shown in FIGS. 1 and 2, the output signal (acceleration, deformation) detected by the sensors 31a can be wirelessly transmitted from the transmitter 44 of the sensors 31a to the controller 51. For this reason, wires for connecting the sensors 31a and the controller 51 are not necessary. Furthermore, the sensors 31a comprise a power generator 34 that produces electric power corresponding to an external force and feeds the power to the transmitter 44.

Because wiring is thus not necessary, the number of wiring components is reduced, the configuration of the vehicle collision detection device 30 can be simplified, and the number of assembly steps can be reduced. As a result, the cost of the vehicle collision detection device 30 can be reduced. Furthermore, the controller 51 (including the unit-side power-supply circuit 54) is separated from the sensors 31a, and the latitude in positioning the vehicle collision detection device 30 with respect to the vehicle 10 can therefore be enhanced. In addition, there is no need to feed electric power from the unit-side power-supply circuit 54 to the sensors 31a, and the power consumption of the unit-side power-supply circuit 54 can therefore be reduced.

In addition, each of the sensors 31a comprises a distinguished-value memory part 42 for storing the characteristic distinguished value for each of the sensors 31a, and a transmitter 44 for transmitting the distinguished value together with the output signal to the controller 51. For this reason, the controller 51 can accurately determine from which of the sensors 31a the output signal was received. Therefore, the controller 51 can accurately assess collisions on the basis of the output signal received from the sensors 31a.

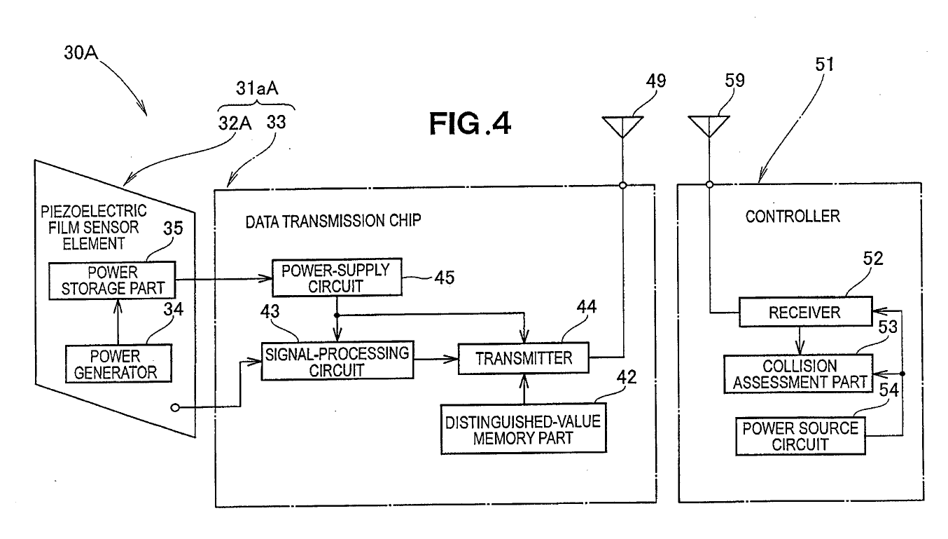

A modification of the vehicle collision detection device 30 according to the first embodiment shall next be described based on FIG. 4. In the modified vehicle collision detection device, the structures identical to those of the first embodiment shown in FIGS. 1 and 2 are assigned the same numerical symbols, and the description of the structures shall be omitted.

As shown in FIG. 4, the modified vehicle collision detection device 30A comprises a power storage part 35 in addition to the vehicle collision detection device 30 of the first embodiment. The configuration is otherwise essentially the same as that of the vehicle collision detection device 30 of the first embodiment.

In other words, the modified vehicle collision detection device 30A has a plurality of sensors 31aA and a controller 51. The sensors 31aA are each composed of a piezoelectric film sensor element 32A and a data transmission chip 33. The piezoelectric film sensor element 32A comprises a power storage part 35 in addition to the power generator 34. The piezoelectric film sensor element 32A has essentially the same construction as the piezoelectric film sensor 32 of the first embodiment.

The power storage part 35 is a memory part for storing the electric power produced by the power generator 34, and for feeding electric power to the chip-side power-supply circuit 45. The power storage part 35 is composed of, for example, a sheet capacitor. The power storage part 35 can be mounted to the piezoelectric film sensor element 32A by adopting a double-layer configuration wherein the capacitor is layered onto the power generator 34.

According to the vehicle collision detection device 30A of the modified example, as shown in FIG. 4, the output signal (acceleration, deformation) detected by the sensors 31aA can be wirelessly transmitted from the transmitter 44 of the sensors 31aA to the controller 51. For this reason, wires for connecting the sensors 31aA and the controller 51 are not necessary. Furthermore, the sensors 31aA comprise a power generator 34 that produces electric power corresponding to an external force and feeds the power to the transmitter 44.

Because wiring is thus not necessary, the number of wiring components is reduced, the configuration of the vehicle collision detection device 30A can be simplified, and the number of assembly steps can be reduced. As a result, the cost of the vehicle collision detection device 30A can be reduced. Furthermore, the controller 51 (including the unit-side power-supply circuit 54) is separated from the sensors 31aA, and the latitude in positioning the vehicle collision detection device 30A with respect to the vehicle 10 can therefore be enhanced. In addition, there is no need to feed electric power from the unit-side power-supply circuit 54 to the sensors 31aA, and the power consumption of the unit-side power-supply circuit 54 can therefore be reduced.

In addition, each of the sensors 31aA comprises a distinguished value memory part 42 for storing the characteristic distinguished value for each of the sensors 31aA, and a transmitter 44 for transmitting the distinguished value together with the output signal to the controller 51. For this reason, the controller 51 can accurately determine from which of the sensors 31aA the output signal was received. Therefore, the controller 51 can accurately assess collisions on the basis of the output signal received from the sensors 31aA.

Furthermore, according to the modified vehicle collision detection device 30A, a power storage part 35 for storing the electric power produced by the power generator 34 is provided to the sensors 31aA, and the electric power stored in the power storage part 35 can therefore be fed to the transmitter 44. For this reason, the power fed from the power storage part 35 to the transmitter 44 can be stabilized even if there are fluctuations in the electric power produced by the power generator 34. The transmitter 44 can therefore transmit a more stable output signal.

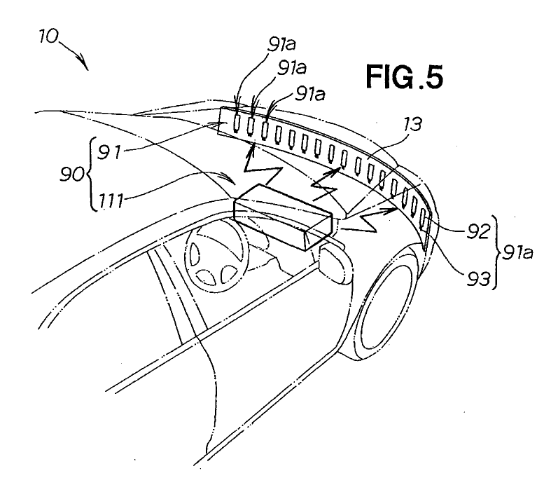

The vehicle collision detection device of the second embodiment shall next be described based on FIGS. 5, 6, and 7. In the vehicle collision detection device of the second embodiment, the structures identical to those of the first embodiment shown in FIGS. 1 and 2 are assigned the same numerical symbols, and the description of the structures shall be omitted.

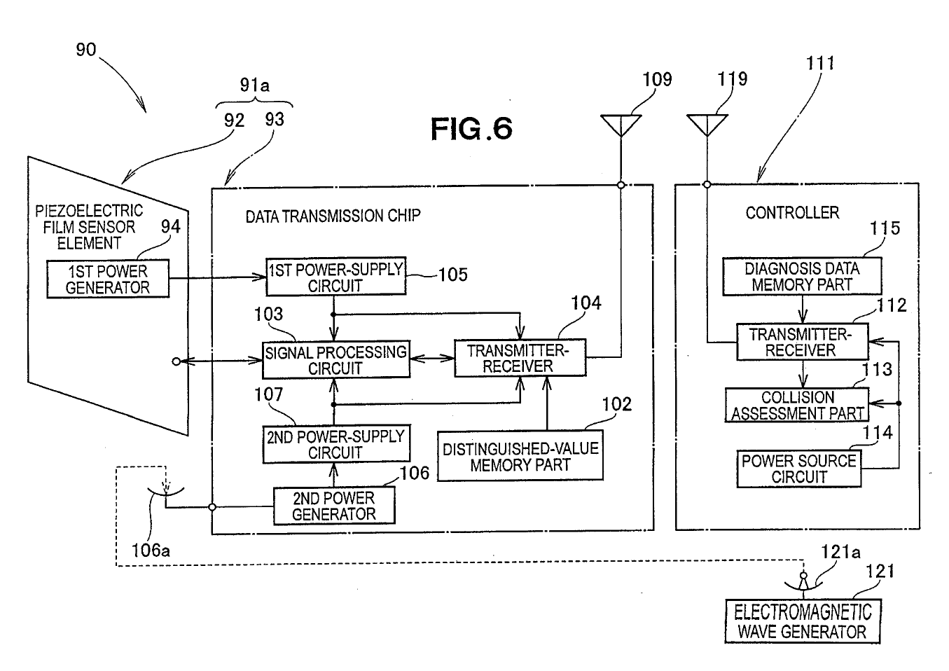

As shown in FIGS. 5 and 6, the vehicle collision detection device 90 according to the second embodiment comprises a collision detection unit 91, a controller 111, and an electromagnetic wave generator 121 (see FIG. 6). The collision detection unit 91 has a plurality of sensors 91a.

One sensor from among the sensors 91a shall now be described in detail. The other sensors 91a have the same configuration. The sensor 91a has a piezoelectric film element 92 and a data transmission chip 93 integrally mounted to the piezoelectric film 92.

The piezoelectric film sensor element 92 (hereafter referred to as the “sensor element 92”) has essentially the same configuration as the sensor element 32 of the first embodiment. The sensor element 92 comprises a first power generator 94 (see FIG. 6). The first power generator 94 has essentially the same configuration as the power generator 34 of the first embodiment. The first power generator 94 may comprise the power storage part 35 shown in FIG. 4.

As shown in FIG. 6, the data transmission chip 93 comprises a distinguished value memory part 102, a signal processing circuit 103, a transmitter-receiver 104, a first power-supply circuit 105, a second power generator 106, a second power-supply circuit 107, and a chip-side antenna 109.

The distinguished value memory part 102 has essentially the same configuration as the distinguished value memory part 42 of the first embodiment. The signal processing circuit 103 has essentially the same configuration as the signal processing circuit 43 of the first embodiment, and converts the detection signal received from the sensor element 92 to an output signal corresponding to acceleration or displacement.

The transmitter-receiver 104 transmits an output signal having a distinguished value to the controller 111 via the chip-side antenna 109, and receives a diagnostic instruction from the controller 111 via the chip-side antenna 109. Specifically, the transmitter-receiver 104 combines and simultaneously transmits the output signal received from the sensor element 92 via the signal processing circuit 103, and the distinguished value received from the distinguished value memory part 102 (i.e., transmits the “output signal having a distinguished value”). Reception of the diagnosis instruction shall be described hereafter.

The first power-supply circuit 105 has essentially the same configuration as the chip-side power-supply circuit 45 of the first embodiment. In other words, the first power-supply circuit 105 rectifies and keeps constant the voltage in the power fed from the first power generator 94. The first power generator 94 feeds electric power to the signal-processing part 103 and the transmitter-receiver 104 via the first power generation circuit 105.

The second power generator 106 produces power using the electromagnetic waves transmitted from the electromagnetic wave generator 121.

Specifically, the electromagnetic wave generator 121 is attached to the inside of the vehicle 10 and, for example, converts electric power to microwaves or another type of electromagnetic wave and transmits the electromagnetic waves toward the sensors 91a via an electromagnetic wave generator 121a.

The second power generator 106 converts the electromagnetic waves received by an electromagnetic wave receiver 106a to electric power. The electric power can thus be fed from the electromagnetic wave generator 121 to the second power generator 106. The second power generator 106 may comprise a power storage part for storing the generated electric power.

The second power-supply circuit 107 rectifies and keeps constant the voltage of the power fed from the second power generator 106. The second power generator 106 supplies electric power to the signal-processing part 103 and the transmitter-receiver 104 via the second power-supply circuit 107.

As shown in FIGS. 5 and 6, the controller 111 (1) assesses collisions on the basis of the output signal having a distinguished value that has been transmitted from the sensors 91a; controls the airbag, seatbelts, and other passenger protection devices on the basis of the results of the assessment; and (2) examines the sensors 91a for failures. As shown in FIG. 6, the controller 111 has a transmitter-receiver 112, a collision assessment part 113, a unit-side power-supply circuit 114, a diagnostic data memory part 115, and a unit-side antenna 119.

The unit-side antenna 119 is a transmitter-receiver antenna for exchanging wireless signals with the chip-side antenna 109.

The transmitter-receiver 112 receives an output signal having a distinguished value via the unit-side antenna 119, and searches for an output signal and a distinguished value by decoding the output signal having a distinguished value.

The collision assessment part 113 evaluates the presence or absence of a collision involving the vehicle 10 (see FIG. 5), the mode of the collision, and the magnitude of the impact force on the basis of the output signal and distinguished value received from the receiver 112, and controls the passenger protection devices on the basis of the results of this evaluation.

The unit-side power-supply circuit 114 supplies electric power to the transmitter-receiver 112 and the collision assessment part 113.

The diagnostic data memory part 115 stores in advance the failure diagnosis data for diagnosing failure in the sensors 91a, i.e., diagnostic instructions.

The vehicle collision detection device 90 performs failure diagnosis in the following order.

First, as shown in FIGS. 5 and 6, the transmitter-receiver 112 of the controller 111 sends out a diagnostic instruction stored in the diagnostic data memory part 115 at a prescribed diagnosis timing, and transmits the instruction to all sensors 91a via the unit-side antenna 119.

The transmitter-receiver 104 in the sensors 91a receives the diagnostic instruction via the chip-side antenna 109, and sends the instruction to the signal processing circuit 103. The signal processing circuit 103 provides the transmitter-receiver 104 with a response signal that corresponds to the diagnostic instruction. The transmitter-receiver 104 combines the individual distinguished value received from the distinguished value memory part 102 with the response signal, and transmits the signal to the controller 111 via the chip-side antenna 109.

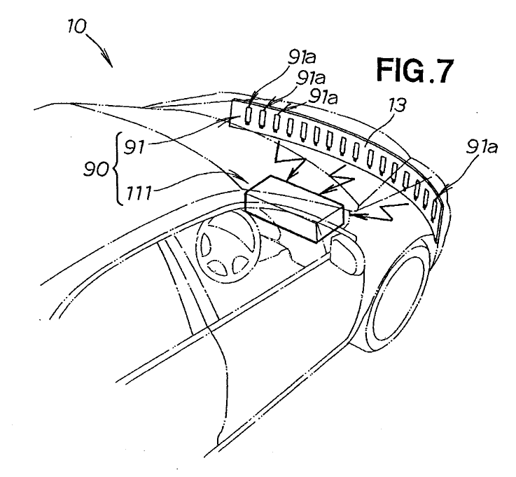

As shown in FIGS. 6 and 7, the transmitter-receiver 112 of the controller 111 receives the response signal via the unit-side antenna 119, and determines the distinguished value and the response signal by decryption. The transmitter-receiver 112 then determines that the vehicle collision detection device 90 is normal when the response signals from all the sensors 91a have been received.

A failed sensor 91a does not generate a signal in response to the diagnosis instruction. The transmitter-receiver 112 can identify the failed sensor 91a by analyzing the distinguished values and response signals sent from the normal sensors 91a.

In this way, the transmitter-receiver 112 can transmit the diagnosis instructions simultaneously to all the sensors 91a, and can perform a failure diagnosis.

The transmitter-receiver 112 of the controller 111 may also have a configuration in which failure diagnosis is performed individually by transmitting a diagnosis instruction to the sensors 91a individually and sequentially, and receiving the response signal that corresponds to the diagnosis instructions.

According to the vehicle collision detection device 90 of the second embodiment, as shown in FIGS. 5 and 6, an output signal (acceleration, deformation) detected by the sensors 91a can be wirelessly transmitted from the transmitter-receiver 104 of the sensors 91a to the controller 111. For this reason, wires for connecting the sensors 91a and the controller 111 are not necessary. Furthermore, the sensors 91a comprise a first power generator 94 that produces electric power corresponding to an external force and that feeds the power to the transmitter-receiver 104.

Because wiring is thus not necessary, the number of wiring components is reduced, the configuration of the vehicle collision detection device 90 can be simplified, and the number of assembly steps can be reduced. As a result, the cost of the vehicle collision detection device 90 can be reduced. Furthermore, the controller 111 (including the unit-side power-supply circuit 114) is separated from the sensors 91a, and the latitude in positioning the vehicle collision detection device 90 in the vehicle 10 can therefore be enhanced. In addition, there is no need to feed electric power from the unit-side power-supply circuit 114 to the sensors 91a, and the power consumption of the unit-side power-supply circuit 114 can therefore be reduced.

The sensors 91a additionally comprise a distinguished-value memory part 102 for storing the characteristic distinguished value of each sensor 91a, and a transmitter-receiver 104 for transmitting the distinguished values together with the output signal to the controller 111. For this reason, the controller 111 can accurately determine from which of the sensors 91a the output signal was received. Therefore, the controller 111 can accurately assess collisions on the basis of the output signal received from the sensors 91a.

Furthermore, according to the vehicle collision detection device 90 of the second embodiment, the sensors 91a each comprise (i) a first power generator 94 for producing electric power corresponding to an outside force and (ii) a second power generator 106 for producing electric power by converting electromagnetic waves received from the electromagnetic wave generator 121 to electric power. The electric power can therefore be supplied from both the first and second power generators 94, 106 to the signal processing circuit 103 and the transmitter-receiver 104.

For example, when the vehicle 10 is in a stopped state and an impact force is not acting on the vehicle body 11 from the outside, the first power generator 94 does not generate electric power corresponding to an external force. However, the signal processing circuit 103 and the transmitter-receiver 104 are capable of operating on only the electric power fed from the second power generator 106. When a diagnostic instruction is sent wirelessly from the controller 111 to the sensors 91a, the signal processing circuits 103 and transmitter-receiver 104 in the sensors 91a adequately receive the diagnostic instruction, and the signal can be processed. Therefore, failure diagnosis can adequately be performed on the sensors 91a at any time without experiencing temporal constraints. As a result, the dependability of the vehicle collision detection device 90 can be further increased.

The present invention is not limited to a configuration in which the sensors 31a, 31aA, 91a are attached to the front bumper face 13, and may have a configuration in which the sensors are attached to the rear bumper face, door, or another location in proximity to the outer surface (the panel covering the vehicle body 11) of the vehicle 10.

The second power generator 106 shown in FIG. 6 may have a configuration in which electric power is produced using the electromagnetic waves of the diagnosis instruction transmitted from the controller 111.

The vehicle collision detection devices 30, 30A, 90 of the present invention are suitable for use in passenger vehicles.

Obviously, various minor changes and modifications of the present invention are possible in light of the above teaching. It is therefore to be understood that within the scope of the appended claims the invention may be practiced otherwise than as specifically described.

1. A vehicle collision detection device comprising:
a plurality of sensors for detecting at least one parameter selected from an acceleration that acts upon a vehicle body from outside and a deformation induced in the vehicle body in accordance with the acceleration, and then wirelessly generating an output signal; and
a controller for assessing collisions based on the output signal received from the sensors, wherein
each of the sensors comprises:
a distinguished value memory part for storing a characteristic distinguished value for each of the sensors;
a transmitter for transmitting the distinguished value together with the output signal to the controller; and
a power generator for producing electric power by an external force and feeding the power to the transmitter.

2. A vehicle collision detection device comprising:
a plurality of sensors for detecting at least one parameter selected from an acceleration that acts upon a vehicle body from outside and a deformation induced in the vehicle body in accordance with the acceleration, and then wirelessly generating an output signal; and
a controller for assessing collisions based on the output signal received from the sensors, wherein
each of the sensors comprises:
a distinguished value memory part for storing a characteristic distinguished value for each of the sensors;
a transmitter for transmitting the distinguished value together with the output signal to the controller;
a power generator for producing electric power by an external force; and a power storage part for storing the electric power produced by the power generator and feeding the power to the transmitter.

3. A vehicle collision detection device comprising:
a plurality of sensors for detecting at least one parameter selected from an acceleration that acts upon a vehicle body from outside and a deformation induced in the vehicle body in accordance with the acceleration, and then wirelessly generating an output signal;
a controller for assessing collisions based on the output signal received from the sensors and wirelessly transmitting a diagnosis instruction to the sensors and performing a failure diagnosis on the sensors; and
an electromagnetic wave generator for wirelessly generating electromagnetic waves to the sensors, wherein
each of the sensors comprises:
a distinguished value memory part for storing a characteristic distinguished value for each of the sensors;
a transmitter-receiver for transmitting the distinguished value together with the output signal to the controller and receiving the diagnosis instruction;
a first power generator for producing electric power by an external force, and feeding the power to the transmitter-receiver; and
a second power generator for receiving the electromagnetic waves from the electromagnetic wave generator, producing electric power by converting the electromagnetic waves to electric power, and feeding the power to the transmitter-receiver.
